(19) United States
(12) Patent Application Publication
(10) Pub. No.: US 2020/0409013 A1
(43) Pub. Date: Dec. 31, 2020

(54) LENS MODULE

(71) Applicant: AAC Optics Solutions Pte. Ltd., Singapore city (SG)

(72) Inventor: Hailong Wang, Shenzhen (CN)

(21) Appl. No.: 16/914,376

(22) Filed: Jun. 28, 2020

(30) Foreign Application Priority Data
Jun. 28, 2019 (CN) PCT/CN2019/093417

(51) Int. Cl. G02B 7/00; G02B 7/02

(52) U.S. Cl. CPC G02B 7/003; G02B 7/022; G02B 7/021

(57) ABSTRACT

A lens module including a lens barrel and a first lens arranged in the lens barrel is provided. The lens barrel includes a barrel portion and a top plate connected together. The first lens and the top plate that is located at an object side of the barrel portion, are respectively provided with first and second connecting portions, which cooperate with each other to fix the first lens and the top plate together. One of the first and second connecting portions is a positioning post, and the other one is a positioning hole. Another lens module includes a lens barrel and two adjacent lenses arranged in the lens barrel, one of the lenses is provided with a positioning hole, the other one is provided with a positioning post, and the positioning hole and the positioning post cooperate with each other to fix the two lenses together.

### TECHNICAL FIELD

The present invention relates to the field of camera lens technology, and, in particular, to a lens module.

### BACKGROUND

With the continuous development of science and technology, electronic devices have continuously developed towards intelligence. In addition to digital cameras, portable electronic devices such as tablet computers and mobile phones are also equipped with lens assemblies.

The lens module in the related art generally includes a lens barrel and a lens group received in the lens barrel, etc. The lens group includes a plurality of lenses, and sizes of the plurality of lenses are different. When the plurality of lenses is installed in the lens barrel, fixing of the lenses is basically achieved by attachment between an outer peripheral surface of the lens and an inner wall of the lens barrel. Therefore, the inner wall of the lens barrel needs to cooperate with the plurality of lenses at the same time, which requires very high processing accuracy of the lenses and the lens barrel, thereby resulting in relatively high production costs. When roundness of an outer diameter of the lens is not good, or when roundness of the inner wall of the lens barrel is not good, assembling of the lens module is relatively difficult, and stability after assembling is also relatively low.

Therefore, it is necessary to provide a new lens module to overcome the above problems.

### SUMMARY

An object of the present invention is to provide a lens module, which can reduce the production cost and assembling difficulty, and then improve stability after assembling.

A lens module includes a lens barrel and a first lens disposed in the lens barrel. The lens barrel includes a barrel portion and a top plate that are connected with each other, the top plate is located at an object side of the barrel portion, and the top plate is formed by being bent and extending from the barrel portion. The first lens is provided with at least one first connecting portion, the top plate is provided with at least one second connecting portion. The at least one first connecting portion and the at least one second connecting portion cooperate with each other in such a manner that the first lens and the top plate are fixed to each other. Each of the at least one first connecting portion is a positioning post, and each of the at least one second connecting portion is a positioning hole; or, each of the at least one first connecting portion is a positioning hole, and each of the at least one second connecting portion is a positioning post.

The present invention enables the first lens and the top plate of the lens barrel to be connected, and the two are positioned and cooperate with each other through the first connecting portion and the second connecting portion, this cooperating method can avoid influence caused by poor roundness of the inner wall of the first lens or the lens barrel, the poor roundness reducing accuracy requirements for the inner wall of the lens barrel or the first lens, can lower the production cost and assembling difficulty and improve the stability after assembling.

In an embodiment, the at least one first connecting portion includes at least two first connecting portions, the at least two first connecting portions are evenly arranged around an optical axis of the lens module, and the at least one second connecting portion includes at least two second connecting portions. The at least two first connecting portions are in one-to-one correspondence with the at least two second connecting portions, and positions of the at least two first connecting portions respectively correspond to positions of the at least two second connecting portions.

In an embodiment, the at least two first connecting portion includes three first connecting portions.

In an embodiment, the first lens includes an optical portion and a peripheral portion surrounding the optical portion, the peripheral portion is in contact with an inner wall of the lens barrel, and the first connecting portion is provided at the peripheral portion.

In an embodiment, the lens module further includes a second lens stacked on an image side of the first lens. The first lens is further provided with a third connecting portion, the second lens is provided with a fourth connecting portion, and the third connecting portion and the fourth connecting portion cooperate with each other in such a manner that the first lens and the second lens are fixed to each other. One of the third connecting portion and the fourth connecting portion is a positioning post, and the other one of the third connecting portion and the fourth connecting portion is a positioning hole

In an embodiment, the third connecting portion and the first connecting portion are staggered on the first lens.

A lens module includes a lens barrel and two lenses that are arranged in the lens barrel and are adjacent to each other. One of the two lenses is provided with a positioning hole, the other one of the two lenses is provided with a positioning post, and the positioning hole and the positioning post cooperate with each other in such a manner that the two adjacent lenses are fixed to each other.

When assembling the lens module, two lenses can be fixedly connected first, and then an entirety of the two lenses fixed together can be loaded into the lens barrel. Compared with the related art where the two lenses respectively cooperate with different parts of the inner wall of the lens barrel, it is equivalent to that the lens module provided in the present invention reduces at least one component that cooperates with the inner wall of the lens barrel, reduces impact of the assembling pressure on the lens barrel and improves the assembling stability, and it is not necessary to consider roundness of outer peripheries of the lenses, in addition, the combination method of the two lenses can also improve decentering conditions of the lenses.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a cross-sectional view of a lens module;

FIG. 2 is a schematic diagram of a first lens; and

FIG. 3 is a cross-sectional diagram of a lens module.

### DESCRIPTION OF EMBODIMENTS

The present invention will be further illustrated with reference to the accompanying drawings and the embodiments.

It should be noted that all directional indications (such as up, down, left, right, front, rear . . . ) in the embodiments of the present invention are only used to explain relative positional relationship, movement, etc. of various components under a specific posture (as shown in the drawings), if the specific posture changes, the directional indications also change accordingly.

In addition, descriptions related to “first”, “second”, etc. in the present invention are for descriptive purposes only and cannot be understood as indicating or implying their relative importance or implicitly indicating the number of technical features indicated. Thus, features defined as “first” and “second” may include at least one of the features explicitly or implicitly. In addition, the technical solutions between the various embodiments can be combined with each other, but they must be based on the ability of those skilled in the art to realize. When the combination of the technical solutions contradicts or cannot be achieved, it should be considered that the combination of such technical solutions does not exist, nor within the protection scope claimed by the present invention.

### Embodiment 1

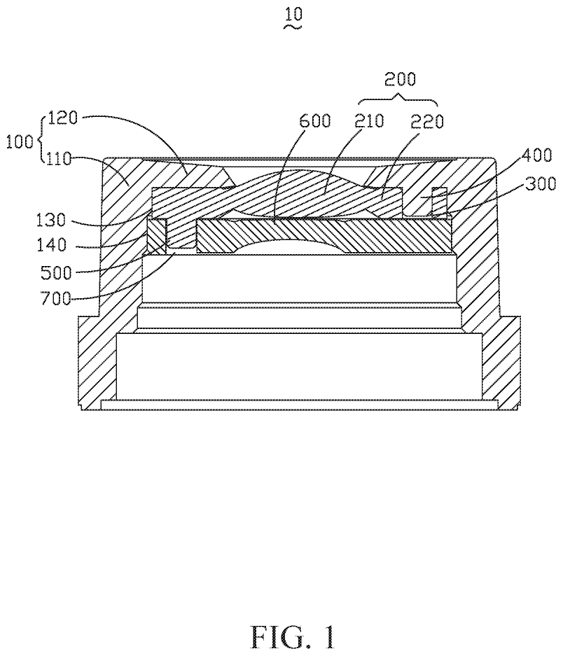

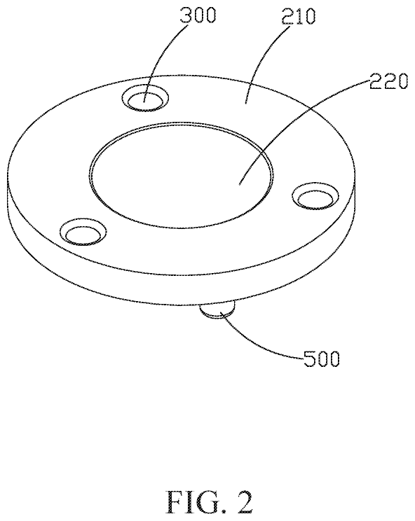

Referring to FIGS. 1 and 2, Embodiment 1 of the present invention provides a lens module 10 including a lens barrel 100 and a first lens 200. The first lens 200 is disposed in the lens barrel 100.

The lens barrel 100 includes a barrel portion 110 and a top plate 120 connected to each other. The barrel portion 110 has a barrel shape with both ends being open, and the top plate 120 has a plate shape. The top plate 120 is located at an object side of the barrel portion 110, and the barrel portion 110 is bent and extended towards an optical axis of the lens module 10 to form the top plate 120. The barrel portion 110 and the top plate 120 are formed into one piece. The first lens 200 is provided with a first connecting portion 300, and the top plate 120 is provided with a second connecting portion 400 at a position corresponding to the first connecting portion 300. The first connecting portion 300 and the second connecting portion 400 cooperate with each other to achieve fixing between the first lens 200 and the top plate 120.

For the lens module 10 of the present embodiment, the first lens 200 and the top plate 120 of the lens barrel 100 are connected to each other and are positioned and cooperate with each other through the first connecting portion 300 and the second connecting portion 400 without precisely cooperating with the inner wall of the barrel portion 110. This cooperating method can avoid influence caused by poor roundness of the inner wall of the lens barrel 100 or the first lens 200, and thus accuracy requirements for the inner wall of the lens barrel 100 or the first lens 200 are also reduced, and the production cost and assembling difficulty are lowered, thereby improving the stability after assembling.

The number of the first connecting portion 300 is two or more, and the two or more first connecting portions 300 are evenly arranged surrounding an optical axis of the lens module 10; correspondingly, the number of the second connecting portion 400 is also two or more, and the two or more first connecting portions 300 are connected with the two or more second connecting portions 400 in one-to-one correspondence.

In an embodiment, the number of the first connecting portion 300 is three, and the number of the corresponding second connecting portion 400 is also three. The lens module 10 of the present embodiment is provided with three first connecting portions 300 and three second connecting portions 400, such that not only a very stable connection relationship between the first lens 200 and the top plate 120 can be ensured, but also increasing of structural complexity of the first lens 200 and the top plate 120 can be avoided.

In an embodiment, the first connecting portion 300 is a positioning hole, the second connecting portion 400 is a positioning post that cooperates with the positioning hole, and the positioning post and the top plate 120 are formed into one piece. The first lens 200 can be stably mounted on the top plate 120 of the lens barrel 100 through tight cooperating between the positioning post and the positioning hole. In another embodiment, the first connecting portion 300 is a positioning post, and the second connecting portion 400 is a positioning hole.

The barrel portion 110 includes a first inner wall 130 close to the top plate 120, a light transmission hole is provided at a center of the top plate 120, and the light transmission hole communicates with an inside of the barrel portion 110. The first lens 200 includes an optical portion 210 and a peripheral portion 220 surrounding the optical portion 210, and a part of the optical portion 210 is located in the light transmission hole. The peripheral portion 220 is in contact with the first inner wall, a size of an outer diameter of the peripheral portion 220 is substantially the same as that of an inner diameter of the first inner wall 130, and since the positioning and cooperating relationship between the two is unnecessary, the accuracy requirements for the outer diameter of the peripheral portion 220 and the inner diameter of the first inner wall 130 can be not too high. The first connecting portion 300 is disposed on the peripheral portion 220, which can ensure that the connection between the first lens 200 and the top plate 120 will not affect light transmission performance of the first lens 200.

In an embodiment, the lens module 10 further includes a second lens 600, and the second lens 600 is stacked on an image side of the first lens 200. The first lens 200 is also provided with a third connecting portion 500, and the second lens 600 is provided with a fourth connecting portion 700. The third connecting portion 500 and the fourth connecting portion 700 cooperate with each other to achieve fixing between the first lens 200 and the second lens 600. It can be understood that the third connecting portion 500 is disposed close to an object side surface of the second lens 600, and correspondingly, the fourth connecting portion 700 is disposed close to an image side surface of the first lens 200.

In the lens module 10 of the present embodiment, the second lens 600 and the first lens 200 are connected to each other, and when assembling the lens module 10, the second lens 600 and the first lens 200 can be fixedly connected first, then the first lens 200 and the second lens 600 as a whole are integrally loaded into the lens barrel 100, to cause the first lens 200 to cooperate with the top plate 120 of the lens barrel 100. Therefore, it is equivalent to that the present invention reduces the components cooperating with the inner wall of the lens barrel 100, which reduces the impact of the assembling pressure on the lens barrel 100 and improves the assembling stability, and it is not necessary to consider roundness of outer peripheries of the first lens 200 and the second lens 600. In addition, the combination method of the first lens 200 and the second lens 600 can also improve decentering conditions of the second lens 600.

The number of the third connecting portion 500 is two or more, and the two or more third connecting portions 500 are evenly arranged surrounding the optical axis of the lens module 10; correspondingly, the number of the fourth connecting portion 700 is two or more, and the two or more fourth connecting portions 700 are connected to the two or more third connecting portions 500 in one-to-one correspondence.

In an embodiment, the number of the third connecting portion 500 is three, and the number of the corresponding second connecting portion 400 is also three. The lens module 10 of the present embodiment is provided with three third connecting portions 500 and three fourth connecting portions 700, such that not only a very stable connection relationship between the first lens 200 and the second lens 600 can be ensured, but also increasing of structural complexity of the first lens 200 and the second lens 600 can be avoided.

In an embodiment, the third connecting portion 500 is a positioning post, the positioning post and the first lens 200 are formed into one piece, the fourth connecting portion 700 is a positioning hole that is cooperate with the positioning post, and the second lens 600 can be stably installed on the first lens 200 through tight cooperating of the positioning post and the positioning hole. In another embodiment, the third connecting portion 500 is a positioning hole, and the fourth connecting portion 700 is a positioning post.

In an embodiment, the third connecting portion 500 and the first connecting portion 300 are staggered on the first lens 200, which can ensure that the installation of the first lens 200 and the installation of the second lens 600 do not affect each other.

It can be understood that, in other embodiments, the lens module 10 includes two or more lenses, and it may also include a third lens, a fourth lens and the like in addition to the first lens 200 and the second lens 600. The third lens can directly cooperate with the inner wall of the lens barrel 100 in order to achieve fixing, and it may also be connected to the second lens 600 in a manner similar to the connection between the second lens 600 and the first lens 200. In order to achieve fixing, the fourth lens can directly cooperate with the inner wall of the lens barrel 100 in order to achieve fixing, and it may also be connected to the third lens in a manner similar to the connection between the second lens 600 and the first lens 200, in order to achieve fixing.

### Embodiment 2

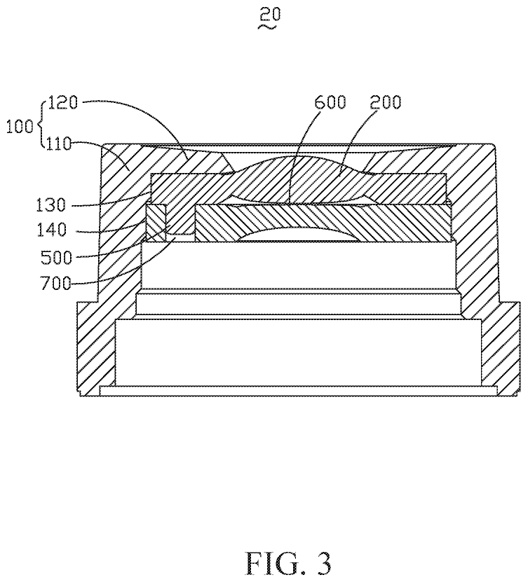

Referring to FIG. 3, Embodiment 2 of the present invention provides a lens module 20. The lens module 20 includes a lens barrel 100 and two lenses that are disposed in the lens barrel and are adjacent to each other. One of the two lenses is provided with a positioning hole and the other one of the two lenses is provided with a positioning post, and the positioning hole and the positioning post cooperate with each other to achieve the fixing between the two lenses.

In the lens module 20 of the present embodiment, the two lenses are fixed together first through the positioning post and the positioning hole and then as a whole loaded into the lens barrel 100. Compared with the related art where the two lenses respectively cooperate with different parts of the inner wall of the lens barrel 100, it is equivalent to that the present embodiment reduces at least one component that cooperates with the inner wall of the lens barrel 100, which reduces impact of the assembling pressure on the lens barrel 100 and improves the assembling stability, and the way of positioning and cooperating of two adjacent lenses can also improve the decentering conditions of the lenses.

The two lenses can be any two adjacent lenses in the lens barrel 100. In an embodiment, the two adjacent lenses are respectively the first lens 200 and the second lens 600 which are sequentially arranged from the object side to the image side of the lens module 20, the first lens 200 is provided with a positioning post, and the second lens 600 is provided with a positioning hole. In another embodiment, a positioning hole is provided on the first lens 200, and a positioning post is provided on the second lens 600.

The number and structure of the positioning post of the present embodiment of the present invention are the same as those of the third connecting portion 500 in Embodiment 1, and the number and structure of the positioning hole in the present embodiment are the same as those of the fourth connecting portion 700 in Embodiment 1, which are not repeated herein.

It should be noted that, the above are merely embodiments of the present invention, those skilled in the art can make improvements without departing from the inventive concept of the present invention, and, these improvements shall belong to the protection scope of the present invention.

What is claimed is:

1. A lens module, comprising:
a lens barrel, wherein the lens barrel comprises a barrel portion and a top plate that are connected with each other, the top plate is located at an object side of the barrel portion, and the top plate is formed by being bent and extending from the barrel portion; and
a first lens disposed in the lens barrel,
wherein the first lens is provided with at least one first connecting portion, the top plate is provided with at least one second connecting portion, the at least one first connecting portion and the at least one second connecting portion cooperate with each other in such a manner that the first lens and the top plate are fixed to each other; and
wherein each of the at least one first connecting portion is a positioning post and each of the at least one second connecting portion is a positioning hole; or each of the at least one first connecting portion is a positioning hole and each of the at least one second connecting portion is a positioning post.

2. The lens module as described in claim 1, wherein the at least one first connecting portion comprises at least two first connecting portions, wherein the at least two first connecting portions are evenly arranged around an optical axis of the lens module; and
wherein the at least one second connecting portion comprises at least two second connecting portions, and the at least two first connecting portions are in one-to-one correspondence with the at least two second connecting portions, and positions of the at least two first connecting portions respectively correspond to positions of the at least two second connecting portions.

3. The lens module as described in claim 2, wherein the at least two first connecting portions comprise three first connecting portions.

4. The lens module as described in claim 2, wherein the first lens comprises an optical portion and a peripheral portion surrounding the optical portion, wherein the peripheral portion is in contact with an inner wall of the lens barrel, and the first connecting portion is provided at the peripheral portion.

5. The lens module as described in claim 1, wherein the first lens comprises an optical portion and a peripheral portion surrounding the optical portion, wherein the peripheral portion is in contact with an inner wall of the lens barrel, and the first connecting portion is provided at the peripheral portion.

6. The lens module as described in claim 1, further comprising:
a second lens stacked on an image side of the first lens,
wherein the first lens is further provided with a third connecting portion, the second lens is provided with a fourth connecting portion, and the third connecting portion and the fourth connecting portion cooperate with each other in such a manner that the first lens and the second lens are fixed to each other; and
wherein one of the third connecting portion and the fourth connecting portion is a positioning post, and the other one of the third connecting portion and the fourth connecting portion is a positioning hole.

7. The lens module as described in claim 6, wherein the third connecting portion and the first connecting portion are staggered on the first lens.

8. A lens module, comprising:
a lens barrel; and
two lenses that are arranged in the lens barrel and adjacent to each other, wherein one of the two lenses is provided with a positioning hole, the other one of the two lenses is provided with a positioning post, and the positioning hole and the positioning post cooperate with each other in such a manner that the two lenses are fixed to each other.
